(19) United States
(12) Patent Application Publication
(10) Pub. No.: US 2004/0107747 A1
(43) Pub. Date: Jun. 10, 2004

(54) Linkage adapted to be controlled by an inner handle to deactivate a primary dead bolt which is controlled by a knob on a door

(76) Inventor: Shih-Chung Chang, Taipei Hsien (TW)

Correspondence Address: DELLETT AND WALTERS, P. O. BOX 2786, PORTLAND, OR, 97208-2786, US

(21) Appl. No.: 10/315,653

(22) Filed: Dec. 9, 2002

(51) Int. Cl. E05B 59/00; E05B 63/14

(52) U.S. Cl. 70/107

(57) ABSTRACT

A door lock linkage is adapted to securely engage with an inner handle and a secondary linkage adapted to be securely engage with a knob to deactivate a primary dead bolt. Engagement between the linkage and the secondary linkage allows the pivotal movement of the inner handle to drive the secondary linkage to pivot so that the primary dead bolt is also driven so that the primary dead bolt is retracted.

### BACKGROUND OF THE INVENTION

1. Field of the Invention

The present invention relates to a door lock linkage, and more particularly to a door lock having a linkage adapted to deactivate a primary dead bolt which is controlled by a knob on a door.

2. Description of Related Art

A door normally has an inner handle and an outer handle to respectively retract the latch so as to open the door. However, when the door is locked from inside at night to prevent any unauthorized personnel to break into the home, the user will have to at least operate the inner handle and the knob to unlock the latch so as to open the door. When there is an emergency inside the house, time is the most important factor for the people to escape outdoors. Therefore, when the door is locked, seconds delay trying to open the door from inside the house might become lethal.

A conventional door usually is equipped with a primary dead bolt controllable by the knob and a latch controllable by both the inner handle and the outer handle. Therefore, for the sake of safety, some householders often lock the door by activating the primary dead bolt at night from the knob. However, when there is a fire or other emergency requiring the family members to escape outdoors, the time necessary to deactivate the primary dead bolt often is the difference between life and death.

To overcome the shortcomings, the present invention tends to provide an improved door lock to mitigate and obviate the aforementioned problems.

### SUMMARY OF THE INVENTION

The primary objective of the present invention is to provide an improved door lock linkage to enable the user to simultaneously deactivate the primary dead bolt and the latch so that even when the primary dead bolt is activated the user will not have to first deactivate the primary dead bolt and then turn the inner handle to deactivate the latch to open the door.

In order to accomplish the foregoing objective, a linkage is adapted to be pivotally mounted on the door lock cover and securely connected to an inner handle shaft. Further the knob has a shaft extending out from the knob to control movement of the primary dead bolt. A secondary linkage is securely mounted on the shaft of the knob to abut a distal end of the linkage such that when the linkage pivots by the inner handle, the secondary linkage is pivoted by the linkage. Therefore, the primary dead bolt is deactivated.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a door equipped with an inner handle and a knob to respectively operate the latch and the primary dead bolt;

FIG. 2 is an exploded perspective view of the door in FIG. 1 to show the structure inside the door, wherein a linkage and a secondary linkage are shown to allow deactivation of the latch deactivates the primary dead bolt;

FIG. 3 is a schematic view of the assembly of the linkage and the secondary linkage with the door without the knob and the inner handle;

FIG. 4 is a schematic view of the interrelationship of the linkage and the secondary linkage when the primary dead bolt and the latch are activated; and

FIG. 5 is a schematic view showing the pivotal movement of the inner handle not only activates the latch, but also activates the primary dead bolt to retract the primary dead bolt inside the door.

### DETAILED DESCRIPTION OF THE PREFERRED EMBODIMENT

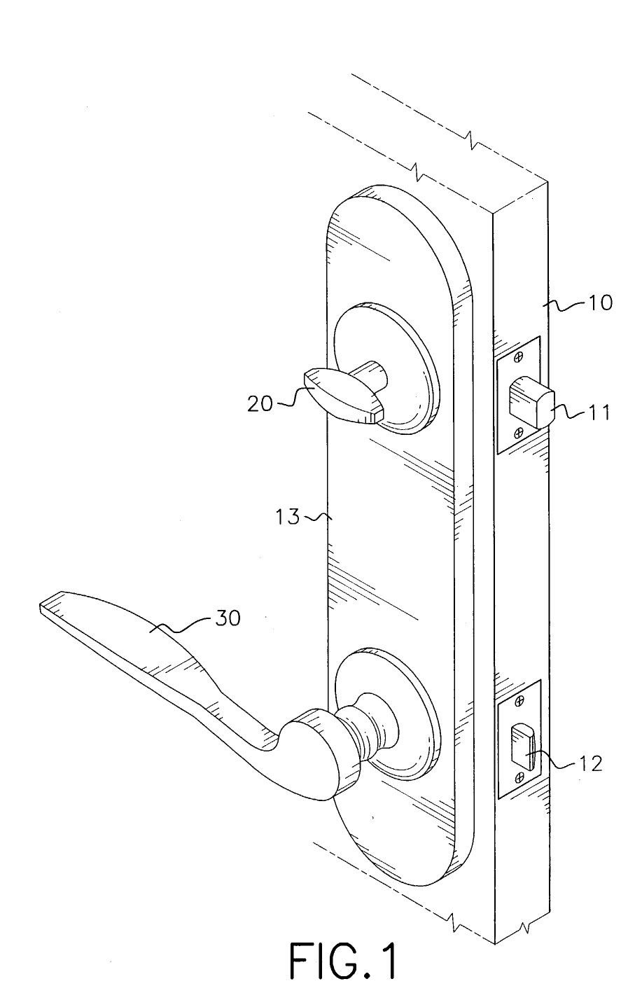

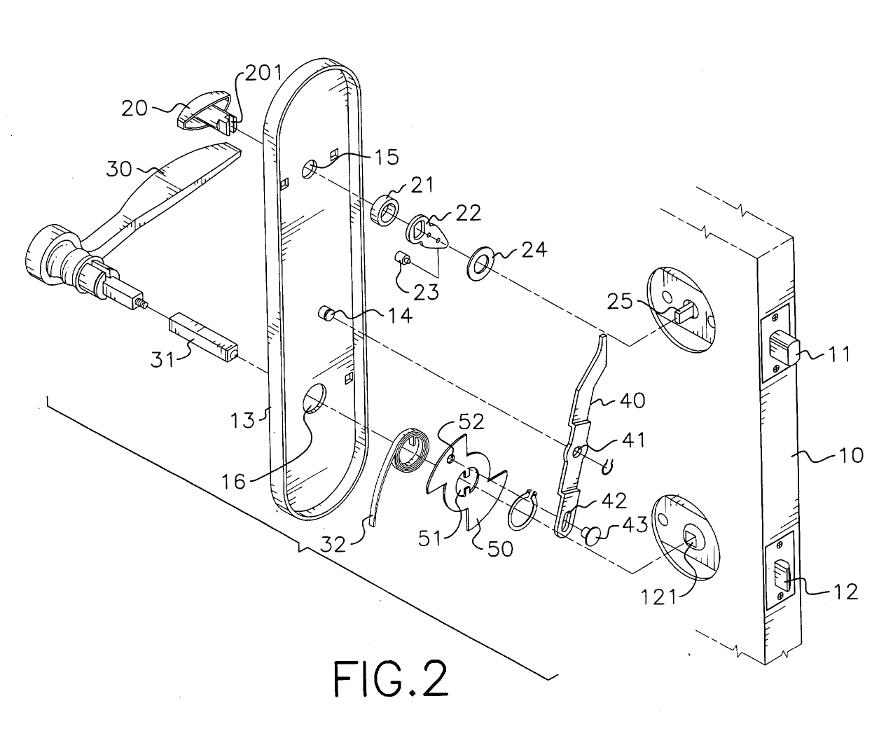

With reference to FIGS. 1 and 2, a door (10) has a knob (20) pivotally mounted on a cover (13) of the door (10) to control activation/deactivation of a primary dead bolt (11) and an inner handle (30) also pivotally mounted on the cover (13) to control deactivation of a latch (12). The cover (13) has a pivot shaft (14) mounted on a side face of the cover (13).

The knob (20) has a shaft (201) integrally extending out from the knob (20) to pass through a first hole (15) defined through the cover (13). A sleeve (21) is provided to mount around the shaft (201). A secondary linkage (22) is securely connected to the shaft (201) after the shaft (201) extends through the first hole (15). The secondary linkage (22) has a roller (23) rotatably mounted at a distal end of the secondary linkage (22). A circular pad (24) is mounted around a first rod (25) which is mounted inside the door (10) and extends out of the door (10).

The inner handle (30) has a driving shaft (31) extending through a second hole (16) defined through the cover (13). A spring (32) is mounted around the driving shaft (31) to maintain the inner handle (30) at a position at all times. A disk (50) has a centrally defined through hole (51) to correspond to the driving shaft (31) such that after the driving shaft (31) extends through the second hole (16) of the cover (13), the driving shaft (31) continues to extend through the through hole (51) in the disk (50) and is mated with a blind hole (121) defined in the door (10).

A linkage (40) has a pivot hole (41) defined in a mediate portion of the linkage (40) to correspond to the pivot shaft (14) of the cover (13), an elongated hole (42) defined in a first end of the linkage (40) to correspond to an aperture (52) in the disk (50). A button (43) is provided to extend through the elongated hole (42) of the linkage (40) and the aperture (52) so as to secure the relative position of the linkage (40) to the disk (50) through the elongated hole (42).

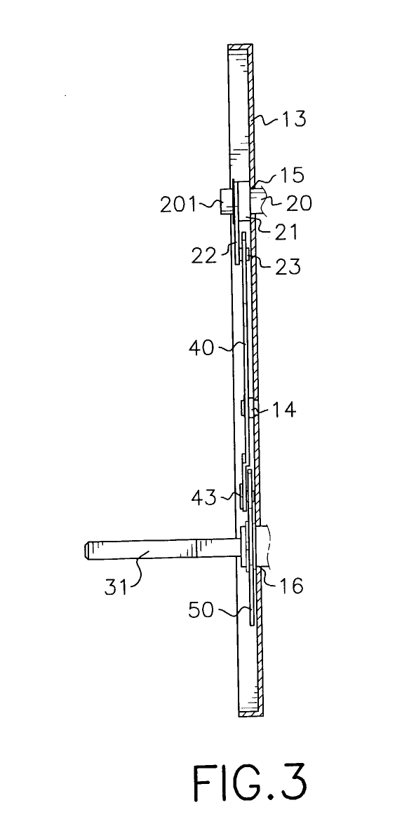

With reference to FIG. 3, after assembly, it is noted that the driving shaft (31) extends through the through hole (51) of the disk (50) and then mates the blind hole (121) of the door (10). Thus, pivotal movement of the inner handle (30) drives the movement of the latch (12). Because the disk (50) is also securely mounted on the driving shaft (31), the pivotal movement of the inner handle (30) also drives the disk (50) to rotate, which drives the first end of the linkage (40) to move.

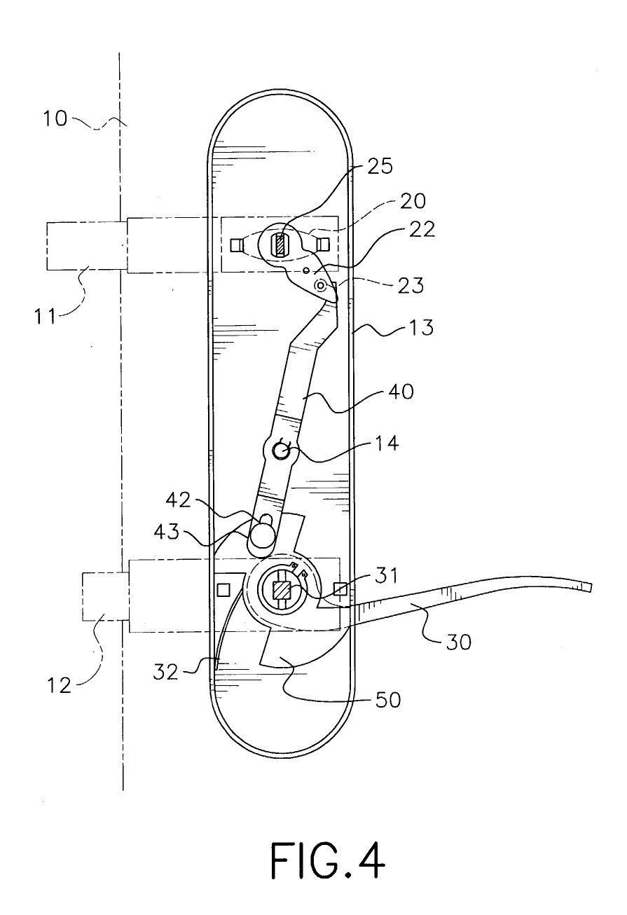

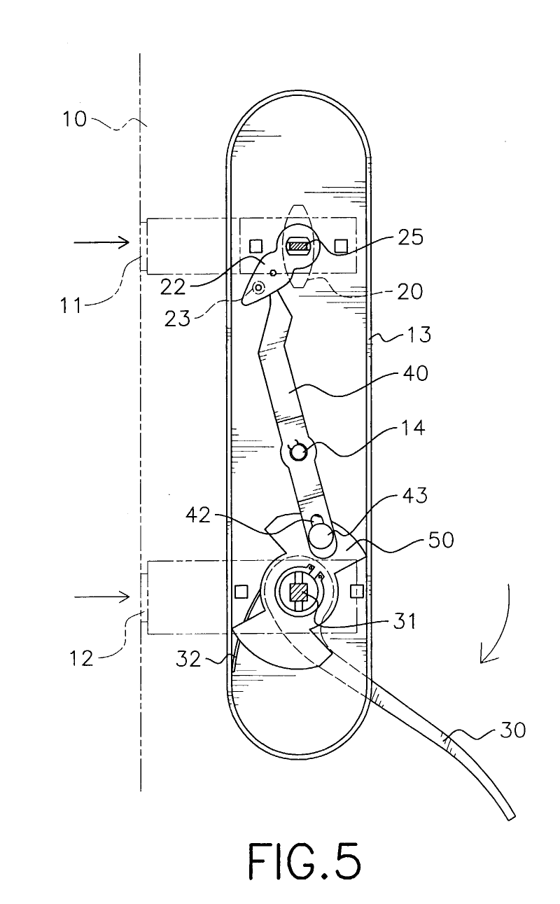

With reference to FIGS. 4 and 5, when the locking mechanism of the door (10) is not activated, the second end of the linkage (40) does not engage the roller (23). However, after the primary dead bolt (11) is activated by the knob (20), as shown in FIG. 2, the second end of the linkage (40) engages with the roller (23).

Therefore, pivotal movement of the inner handle (30) drives the linkage (40) to pivot as well, which allows the second end of the linkage (40) to push the roller (23) of the secondary linkage (22). Thus, the primary dead bolt (11) is retracted by the inner handle.

From the foregoing description, it is asserted that when there is an emergency, persons inside a house can quickly escape outdoors by just operating the inner handle even when the primary dead bolt is activated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a door having an inner handle pivotally mounted on a cover to control retraction of a latch, a knob pivotally mounted on the cover to control activation/deactivation of a primary dead bolt, wherein the improvement comprising:
a linkage is adapted to be securely engaged with the inner handle and pivotally mounted on the cover such that the pivotal movement of the inner handle drives the linkage to pivot;
a secondary linkage is adapted to be securely connected to the knob such that the pivotal movement of the knob drives the secondary linkage to pivot, wherein the secondary linkage selectively engages with a distal end of the linkage so that when the primary dead bolt is activated, the engagement between the secondary linkage and the linkage allows the pivotal movement of the inner handle to drive not only the latch but also the primary dead bolt.

2. The door as claimed in claim 1, wherein the secondary linkage further has a roller rotatably mounted on the secondary linkage to engage with the distal end of the linkage.
